(19) United States
(12) Patent Application Publication
(10) Pub. No.: US 2022/0283698 A1
(43) Pub. Date: Sep. 8, 2022

(54) Method for operating an electronic device in order to browse through photos

(71) Applicant: ORANGE, Issy-les-Moulineaux (FR)

(72) Inventors: Zhihong Guo, Beijing (CN); Cheng Chen, Beijing (CN)

(21) Appl. No.: 17/625,578

(22) PCT Filed: Jul. 2, 2020
(86) PCT No.: PCT/IB2020/000577

§ 371 Date: Jan. 7, 2022

(30) Foreign Application Priority Data
Jul. 8, 2019 (CN) PCT/CN2019/095147

(51) Int. Cl. G06F 3/04845; G06F 3/04842; G06F 3/0488; G06F 3/04847

(52) U.S. Cl. CPC G06F 3/04845; G06F 3/04842; G06F 3/0488; G06F 3/04847; G06F 2203/04806; G06F 2203/04808

(57) ABSTRACT

A method for operating an electronic device. The method includes the following, performed by a processing unit of the device: determining that a first image, selected for being displayed at an interface, depicts at least a first object of interest; and displaying, at the interface, the first image automatically zoomed in on the first object of interest.

### FIELD OF THE INVENTION

The field of the present invention is that of interfaces for browsing through images such as photos. More particularly, the present invention relates to a method for operating an electronic device in order to browse through images such as photos.

### BACKGROUND OF THE INVENTION

With modern mobile terminals such as smartphones, people are likely to take hundreds or even thousands of photos, which can be stored in the built-in flash memory of such mobile terminals. Then, the stored photos can be browsed from time to time using a dedicated application, or shared to family and friends.

When the user opens a photo on a mobile terminal, the photo is displayed in default size which will match the screen size of the display of the mobile terminal.

Nevertheless, mobile terminals often have a rather small screen, so that the user may have to zoom the photo manually to get clear view of a specific portion of the photo (depicting an object of interest such as for instance a face, a pet, a detail, etc.), which may be cumbersome and not very user-friendly, especially when this has to be done for a great quantity of photos.

Moreover, if there are several of such objects of interest in the same photo (typically a gallery of portraits or a photo of a group of people), the user has even to alternatively zoom in and zoom out numerous times, which is very cumbersome.

There is consequently a need for a method allowing improving user experience on photo browsing.

### SUMMARY OF THE INVENTION

For these purposes, it is hereby proposed a method for operating an electronic device characterized in that it comprises the following steps of, performed by a processing unit of the device:
determining that a first image, selected for being displayed at the interface, depicts at least a first object of interest; and
displaying, at the interface, said first image automatically zoomed in on said first object of interest.

Preferred but non limiting features of this method are as follow:

The method comprises detecting an image selection action at the interface, the display of said image automatically zoomed in on said first object of interest being triggered by the detection of the image selection action;

said interface is a touch-sensitive screen and said image selection action is an action among a swipe touch gesture performed on a previous image in a group of images whereof said first image belongs to or a touch gesture on a thumbnail picture of said image in an album object displayed at said interface;

the method further comprises detecting a zoom adjustment action at said interface and adjusting at least one zoom parameter used for automatically zooming in on the first object of interest, depending on said zoom adjustment action;

said interface is a touch-sensitive screen and said zoom adjustment action is a pinch in or pinch out gesture for adjusting a zoom ratio used for automatically zooming in on the first object of interest or a sliding gesture for adjusting a focal point used for automatically zooming in on the first object of interest;

the method further comprises detecting an image swapping action at said interface, in particular a fast swipe touch gesture, and performing the determining and displaying steps for a second image selected following said image swapping action;

said interface is a touch-sensitive screen and said image selection action is a touch gesture by the user, in particular a fast swipe gesture;

when it is determined that said image depicts a plurality of objects of interest including said first object of interest and a second object of interest, the method further comprises selecting the first object of interest among the plurality of objects of interest before displaying said image automatically zoomed in on said first object of interest;

the method further comprises detecting an object of interest zoom swapping action at said interface and displaying at the interface said first image automatically zoomed in on the second object of interest;

said interface is a touch-sensitive screen, said zoom swapping action at said interface being a predetermined touch gesture by the user, in particular a slow swipe touch gesture;

the method further comprises selecting the second object of interest among the plurality of objects of interest before displaying said image automatically zoomed in on the second object of interest;

a zoom ratio applied during the display of an image automatically zoomed in on an object of interest is function of the size of an area containing said first or second object of interest and the total size of the first image;

the method comprises detecting a zoom cancelling action on said interface and displaying at the interface said first image without any zooming in on an object of interest.

According to a second aspect, it is hereby proposed an electronic device comprising a processing unit and an interface, characterized in that the processing unit is configured to implement:
determining that a first image, selected for being displayed at the interface, depicts at least a first object of interest; and
displaying, at the interface, said first image automatically zoomed in on said first object of interest.

According to a third and a fourth aspects, it is proposed a computer program product comprising code instructions for executing a method according to the first aspect for operating an electronic device, and a computer-readable medium, on which is stored a computer program product comprising code instructions for executing a method according to the first aspect for operating an electronic device.

### BRIEF DESCRIPTION OF THE DRAWINGS

The above and other objects, features and advantages of the present invention will be apparent in the following detailed description of an illustrative embodiment thereof, which is to be read in connection with the accompanying drawings wherein:

FIG. 1 illustrates an example of architecture in which an embodiment of the method according to the present invention may be performed;

FIG. 2 is a diagram representing steps of an embodiment of a method according to the invention; and

FIGS. 3A-3C illustrate an example of a group photo on which is applied an embodiment of the method according to the present invention.

### DETAILED DESCRIPTION OF AN EMBODIMENT OF THE PRESENT INVENTION

### Architecture

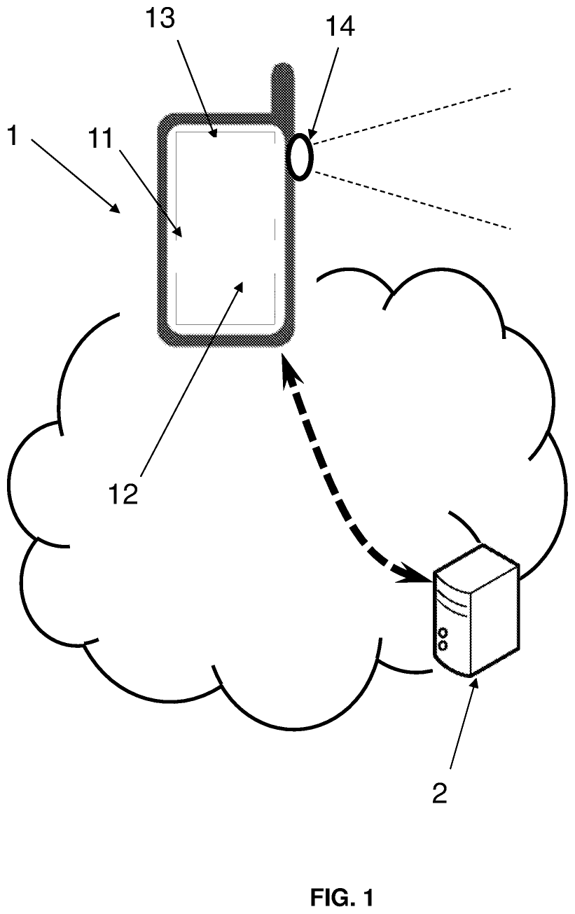

The present invention relates to a method for operating an electronic device 1 as represented by FIG. 1. The device 1 comprises a processing unit 11, i.e. a CPU (one of mode processors), an interface 13 (typically a screen, possibly touch sensitive), a storage unit 12 (e.g. a memory, for instance flash memory) and possibly an acquisition unit 14, i.e. means for acquiring a picture of any view in front of the device 1 (e.g. a camera).

The device 1 also typically comprises a battery for powering the processing unit 11 and other units. The device 1 may further comprise others units such as a location unit for providing location data representative of the position of the device 1 (using for example GPS, network triangulation, etc.), further sensors (such as an acceleration sensor, light sensor, etc.), a communication unit for connecting (in particular wirelessly) the device 1 to a network 20 (for example WiFi, Bluetooth, or a mobile network, in particular a GSM/UMTS/LTE network, see below), etc.

This device 1 is typically a smartphone, a tablet computer, a laptop, etc. In the following description the example of a smartphone will be used, but the present invention is not limited to this embodiment as it is well known that nearly any electronic device 1 with an interface 13 is able to display an image.

### Image

The present method aims at controlling the user interface 13 of the electronic device 1. More precisely, as it will be explained, the present method is for automatically zooming/moving a first image displayed at the interface 13. It will be understood that by “zooming”, is it meant varying the zoom, in other words either “zooming in”, i.e. enlarging the first image, but also further “zooming out”, i.e. reducing the first image (typically zooming back, i.e. reverting to the initial size after zooming in, see below).

The present method is performed by the processing unit 11 of the device 1, and is implemented either by an application of the device displaying images (a photo viewer, a mapping service, the camera, etc.), a dedicated software application, or directly by the operating system. The first image may be stored on the memory 12, retrieved from a remote server 2 of the network 20 (if for instance shared by another user), etc. It is to be noted that the first image could also be the live input of the camera 14 of the device 1. Note that this first image may belong to a group of images (typically constituting an album), including thus at least one other image, referred to as second image. There might be further third, fourth, etc. images.

The word “image” designates here any graphic object at least partially displayable by the screen 13, typically a photo.

Such an image typically depicts one object of interest, or even a plurality of objects of interest. By convenience, one object of interest will be referred to as first object of interest, and the possible other objects will be referred to as second, third, etc. objects of interest. The present method allows automatically zooming in on objects of interest, as it will be described. Therefore, the user does not have any more to manually zoom in/zoom out, leading to an improved user experience.

By “object of interest” (abbreviated OOI), it is meant any meaningful and identifiable object depicted by the first image (or the other second, third, etc. images as well), i.e. occupying a given area of the first image on which the user may wishes to zoom in, such as faces, pets, cars, signs, etc. The objects of interest may depend on the type of image. For example, if the first image is a group photo, the objects of interest are likely to be faces. If the first image is a wildlife picture, the objects of interest are likely to be animals. If the image is a map, the objects of interest are likely to be cities. The objects of interest may be automatically detected or tagged by the user, as explained below.

Note that an object of interest may actually be a “group” of elementary objects of interest. For example, if there are three close faces depicted in the same image, the set of these three faces may be considered as a single object of interest, as there will be no point in automatically zooming in individually on each of these faces because of their proximity. The decision to “merge” several elementary objects of interest into a larger object of interest (i.e. to consider these elementary objects of interest as a single object of interest instead of several ones) may depend on the distance between these elementary objects of interest. For example, if the distance between these elementary objects of interest is below a threshold such as one third of the width of the interface screen 13 (expressed for instance as a number of pixels of the screen), these elementary objects of interest may form a single object of interest.

In the following description the example of a photo depicting faces on which the user wants to individually focus will be taken, but the invention is not limited to this embodiment.

### Method for Operating an Electronic Device

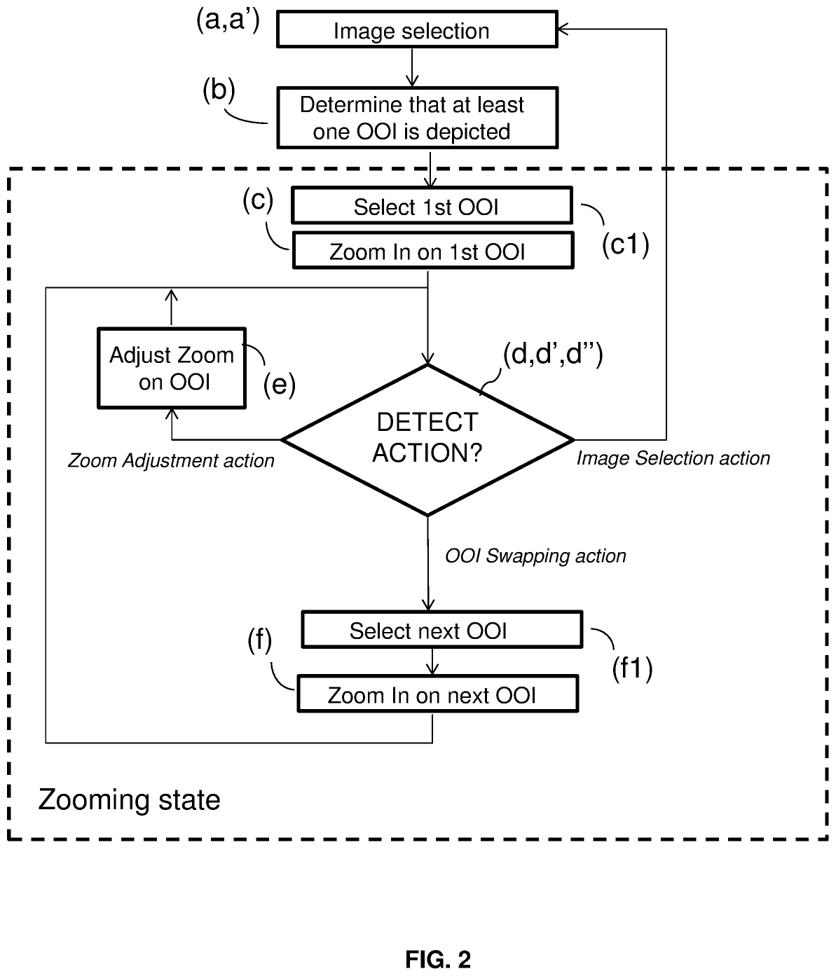

With reference to FIG. 2, the present method may first comprise a step (a) of detecting an image selection action at the interface 13, so as to select a first image to be displayed, this first image potentially depicting at least a first object of interest.

This step (a) may comprise initially displaying at the interface 13 the first image, in order to enable its selection by a user. Note that this initial display may be done using a default zoom ratio, for example fit to full screen (no zoom applied, i.e. without any zooming in on an object of interest) in particular if the image is a photo, or using a given scale if the image is a map.

As explained, the image selection action aims at selecting the first image on which the method is to be performed. In an embodiment wherein the interface 13 is a touch-sensitive screen, the image selection action may be a touch gesture performed by the user on the touch-sensitive screen, in particular a predetermined touch gesture such as a swipe touch gesture (in particular a fast swipe touch gesture or a two fingers swipe gesture, see below) performed on a previous image in a group of images whereof the first image belongs to or a touch input (in particular a normal touch gesture) on a thumbnail picture of the first image in an album object displayed at the interface 13. Note that there may be a plurality of possible image selection actions, including possibly an image swapping action (see below).

By swipe touch gesture, it is meant touching while moving the finger(s) on the interface 13 (if several fingers, they move but do not pinch), in particular toward the left or the right for selecting the previous or the next image. Note that other touch gestures such as a long duration touch gesture (i.e. a continuous normal touch, for instance lasting at least a duration threshold such as 0.5 seconds), a high force touch gesture (i.e. a touch gesture with a pressure exceeding a force threshold, if the screen 13 includes a “3D touch” technology allowing different pressure levels) or a double touch gesture may be used for swapping the image (i.e. the “next” image is selected. If a first image has always been selected, a second image may be selected, etc.).

By “fast swipe touch gesture”, it is meant a swipe touch gesture which is not a long duration gesture, i.e. with the finger moving during a period below a threshold (for instance less than 0.5 seconds). The opposite, a “slow swipe touch gesture”, is a swipe touch gesture which is also a long duration gesture, i.e. with the finger moving during a period exceeding a threshold (for instance more than 0.5 seconds) and consequently needing more time to cross the screen. By contrast with all these gestures, a normal touch gesture is a simple touch gesture (brief, normal pressure and motionless touch gesture) on the thumbnail of the first image, e.g. a click on a screen.

In a following step (b), it is determined if this first image, selected for being displayed at the interface 13, depicts at least a first object of interest.

In a first embodiment, this determining step (b) is triggered directly by the selection of the first image and thus is performed systematically for any image selected by a user.

In another embodiment, a visual sign such as a button is displayed at the interface 13 (for instance in the settings of a photo gallery application or in a menu button) to let a user switch between a normal image view mode and a view by object of interest mode. In this embodiment, once the view by object of interest mode is being switched on using this button, the determining step (b) is triggered directly by the selection of a first image.

For the purpose of determining whether a first object of interest is depicted, the determining step (b) may comprise identifying one or more objects of interest depicted in the selected first image. This identification may be performed using image analysis based on machine learning.

In particular, deep learning algorithms, such as YOLO (“you look only once”) are known to the skilled person and can be used here. Such deep learning algorithms use a neural network, for instance a convolutional neural network (CNN), which typically contains feature extracting layers (convolution and/or pooling layers), and at least one final object identification layer (typically a fully connected layer). Some of the AI libraries, like TensorFlow on Android, can mark the face and recognize a face based on calculating the similarity of the face to be recognized with the face already recognized or tagged by user, in real time.

Such identification may also be preprocessed for a plurality of images, and for each of these images, object(s) of interest depicted therein may be stored respectively in association with a zoom ratio value (or a value n when the zoom ratio is defined by the formula n*p/f, as explained later) to be applied and a location parameter of the object of interest within the image (for instance, the coordinates c of this object of interest in this image or the coordinates of a focal point fp located sensibly at the center of an area surrounding the object of interest). In that case, during this determination step (b), the previously identified object(s) of interest depicted in the selected first image are just retrieved then (without having to perform a real-time analysis of the selected image), with any associated zoom parameter(s) to use.

As previously explained, examples of objects of interest may be faces that either have been tagged previously by the user or that appeared most frequently in user's photo booth. For example, the faces tagged as “wife”, “son”, “daughter” etc. may be chosen as face(s) relevant for the user and just identified as objects of interest. Alternatively or in addition, the user may designate a type of object (such as “cars”), and the first image is processed for detecting and automatically tagging such objects, using for example deep learning. Alternatively or in addition, the user may zoom and move the portion to be displayed manually, and the object in the displaying portion in the first image may be detected and recorded as object of interest (and the image can be processed for identifying similar objects as other objects of interest).

As also explained, groups of elementary objects of interest may be merged into a single object of interest. The present invention will not be limited to any way of obtaining the object(s) of interest.

If it is determined that the selected first image does not depict any object of interest at all (for instance because it is a picture of a natural landscape depicting neither human persons, nor interesting subjects), then the first image is displayed at the interface 13 in a conventional way, i.e. without any automatic zoom in performed on a portion of this first image.

On the contrary, if it is determined that the selected first image depicts a first object of interest, then, in a further step (c), the device 1 displays at the interface 13 this first image automatically zoomed in on this first object of interest.

By “zoomed in on the first object of interest”, it is meant that this displaying step (c) results in displaying, at the interface 13, a portion of the first image containing the first object of interest, for instance a portion sensibly centered on this first object of interest, in other words focused on the first object of interest. It is to be understood that this zooming in may be performed automatically, and thus totally independently from any possible user action following the image selection.

Zooming in the first image corresponds to multiplying its dimension by a zoom ratio which has always a value at least equal to one. The first image is then generally cropped out, so as to match the dimension of the interface 13 when zoomed in on an object of interest it depicts. Such a zoom in operation may be thus performed by centering this zoom in on a focal point fp in the first image, which corresponds to the location of the object of interest to be zoomed in (typically, the object of interest is approximatively centered on such a focal point fp) and applying a zoom ratio.

In an embodiment, the zoom ratio is function of the size of an area containing the first object of interest to be zoomed in and the total size of the screen 13, in particular according to the function Zoom_ratio=n*p/f, wherein p is the total size of the screen 13, f the size of the area containing the first object of interest, and n a constant value representing a suitable ratio between the size of an object of interest and the total size of the screen 13, for instance 0.2. As an example, a face measuring 5% of the screen size (thus with p/f=20) and a value of n=0.2 will trigger a zoom in by a zoom ratio value of 4.

The first image may be directly displayed in the zoomed in aspect. Alternatively, the step of displaying (c) at the interface 13 the first image automatically zoomed in on the first object of interest may comprise progressively zooming in the first image, i.e. the first image is initially displayed without any zooming in on an object of interest (if it has not been done during step (a)) and then focusing the display on the first object of interest by progressively enlarging the zoom in ratio, instead of directly appearing in the zoomed in aspect. The duration of the enlargement may be done to mimic a manual zooming in.

In a first embodiment, the display of the first image automatically zoomed in on the first object of interest is triggered by the detection of the image selection action. In other words, at the interface 13, the first image is directly displayed automatically zoomed in on the first object of interest.

In a second embodiment, following an initial display during step (a) of the first image, the display of the image automatically zoomed in on the first object of interest is triggered by the detection of a zoom activation action performed by the user at the interface 13. Indeed, as explained, the user may wish to see more closely the object(s) of interest in the first image. It is to be understood that, as soon as the user changes the zoom, the user wishes to have a better view of the object(s) of interest: here, the user does not have to necessarily zoom toward a specific area of the first image containing the first object of interest: any zoom activation action performed on the selected image by the user will trigger here the display of the first image zoomed in on the first object of interest.

In an embodiment wherein the interface 13 is a touch-sensitive screen, such zoom activation action is generally a zooming in action and in particular a zooming in touch gesture, such as the “pinch” gesture with two fingers (e.g., the thumb and the index finger of the right hand of the user), preferably a fast zooming in touch gesture.

More precisely, a so-called pinch-out or outward pinch gesture is known as a user's action or gesture required for zoom in (i.e. enlargement) of an image displayed in the interface. The pinch-out gesture is a gesture in which the user moves the two fingers farther apart while touching the touch screen with those two fingers. In contrast, a gesture required for zoom out (i.e. reduction) of the first image is a pinch-in or inward pinch gesture in which the user moves two fingers closer together. By fast pinch gesture, it is meant a pinch gesture wherein both fingers keep touching during a period less than a threshold such as 0.5 seconds). Note that the given zoom-in touch gesture may be also a particular swipe touch gesture (for instance touching while moving the finger according to a pattern, for example circles), a long duration touch gesture, a high force touch gesture or a double touch gesture, among others. As it will be explained below, there might be a zoom cancellation action, generally a zooming out action

It is to be understood that the zooming in of step (c) may be automatically performed, and thus may be totally independent from the possible zoom activation action which has triggered the displaying step (c). In other words, no matter if the user has performed a large or small zooming in touch gesture, the automatic zooming in on the first object of interest is performed in the same way.

### Zoom Adjustment

In any case, when displaying the first image zoomed in on a first object of interest, the interface 13 has entered into a “zooming state” and the user may then manually adjust the zoom on this first object of interest, by performing a zoom adjustment action on the interface 13. Such a zoom adjustment action, when detected (d) by the electronic device 1, triggers the adjustment (f) of the zoom on the first object of interest.

Such an adjustment may consist in adjusting the zooming ratio by zooming in/out using a particular zoom action such as previously explained (e.g. pinch in/pinch out gesture, in particular a slow pinch gesture, i.e. a pinch gesture but both finger keep touching during a period exceeding a threshold such as 0.5 seconds. Alternatively, the zooming adjustment action may be any zooming in/out action different from the zoom activation action, such as a high force gesture if the zoom activation action is a pinch gesture). Alternatively a “zooming adjustment mode” may be triggered after for instance a long duration touch, then any zooming in/out action during this mode could be a zoom adjustment action.

This manual adjustment may then result in modifying the value of n for further automatic zooming. As an example, if after an automatic zoom in by a zoom ratio of 4, the user manually further zooms in by 10% (i.e. the user wishes to see even more clearly the object of interest), the value of n may change from 0.2 to 0.22.

This adjustment may also consist in adjusting the center of the zooming in operation (for instance if the user is not satisfied with the position of the automatic zoom in with respect to the object of interest) by using a particular action such a sliding gesture. This manual adjustment may then result in modifying the value of a location parameter of the first object of interest in the image, e.g. its coordinates in the image (typically the coordinates of the focal point fp on which this object is sensibly centered in the image).

Once set, possibly after having been manually adjusted, the value of n (or the zoom ratio), the size f of the area surrounding the object of the interest, the size p of the selected image and/or the value of the location parameter (e.g. its coordinates in the image) for each object of interest in a given image is advantageously stored in the electronic device 1. As an example, if ten objects of interest have been detected to be depicted in nine different photos, ten values of n, possibly ten values f and/or ten values of a location parameter may be stored (one for each object of interest), though it is possible that most of these values of n are the same (e.g. 0.2) and also that most, if not all, of the size values f of the areas surrounding the objects of interest are the same. This way, in a specific embodiment, every time it is determined that an image to be displayed depicts an object of interest on which the automatic zooming in should be performed, it is also verified if a value of n (and possibly of f) has already been stored in association with this object of interest in this image. If that is the case, this value can be retrieved and used as the zoom in ratio for focusing on this object of interest in this image.

Below is an illustrative table describing a situation with a first image depicting three objects of interest and a second image depicting two objects of interest, which could be stored in a memory of the electronic device 1.

In this exemplary table, values of n and the coordinates (expressed in a proportional range [0;1] with respect to the total width and length of the image) of the focal point fp on which a corresponding object of interest is sensibly centered, are stored. It is assumed here that all the areas containing the objects of interest have the same size f, and thus that is not necessary to store values of f.

| Image | OOI | Value of n | fp coordinates |
|---|---|---|---|
| Im₁ | OOI₁ | 0.2 | (0.25; 0.75) |
| | OOI₂ | 0.2 | (0.75; 0.25) |
| | OOI₃ | 0.22 | (0.5; 0.5) |
| Im₂ | OOI₁ | 0.3 | (0.5; 0.5) |
| | OOI₂ | 0.2 | (0.2; 0.2) |

### Plurality of Objects of Interest

If it is determined that the first image depicts a plurality of objects of interest including not only the first object of interest, but also a second object of interest, the method may comprise a further step of displaying (f) at the interface 13 the first image automatically zoomed in on the second object of interest, i.e. on the next object of interest.

This displaying step (f) is performed after detecting (d′) a “object of internet swapping” action (also named “OOI swapping action”), different from a zoom adjustment action as previously described or from an image selection action as explained later, performed by a user on the interface 13. In the case wherein the interface 13 is a touch-sensitive screen, this OOI swapping action on the interface 13 is typically another touch gesture performed by the user, different from the above-mentioned image selection gesture and/or zooming in touch gesture.

In other words, during the “zooming state” (see FIG. 2), an “OOI swapping” action may be used to “switch” from an object of interest to another. Again, the transition is either direct (the first image is re-displayed) or progressive, so that the display of the first image is displaced from the zoomed in area around the first object of interest to the zoomed in an area around the second object of interest. If the first and second objects have different sizes, there may be a further zooming in/out according to this size (again, the first image is typically zoomed by a zoom ratio which is function of the size f of an area containing the second object of interest and the total size p of the first image). The duration of this displacement may be done to mimic a manual displacement.

This OOI swapping action may be a predetermined touch gesture for zoom swapping, for instance a swipe touch gesture. This swipe touch gesture may be a slow swipe touch gesture, by contrast with a fast swipe touch gesture that may be used as explained to switch to next/previous image as image selection action.

Note that steps (d′) and (f) may be repeated so as to display the first image automatically zoomed in on third, fourth, etc. objects of interest.

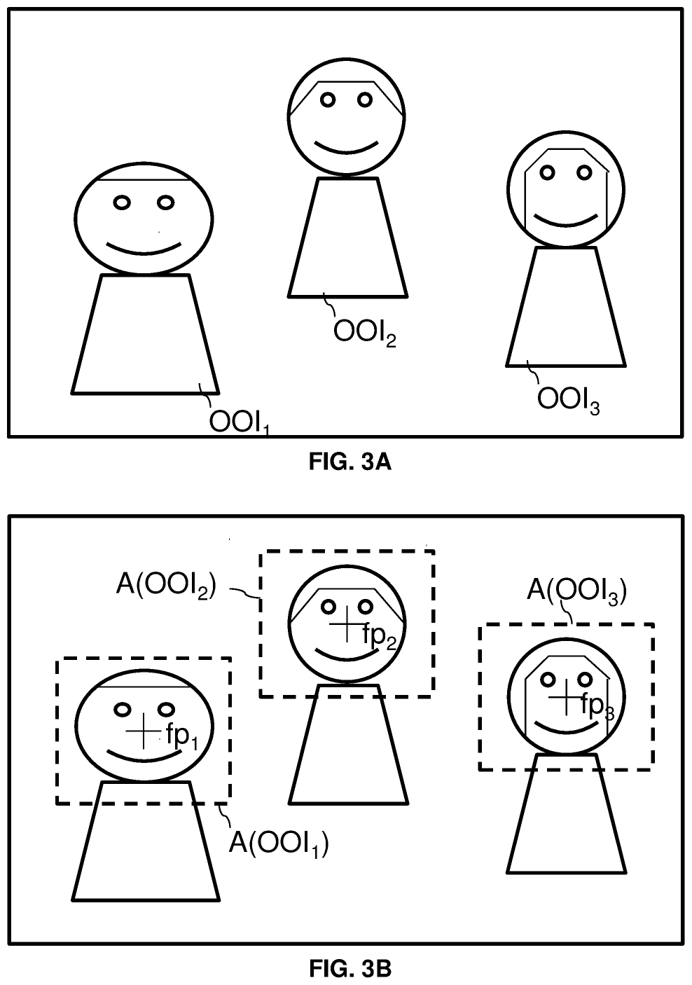

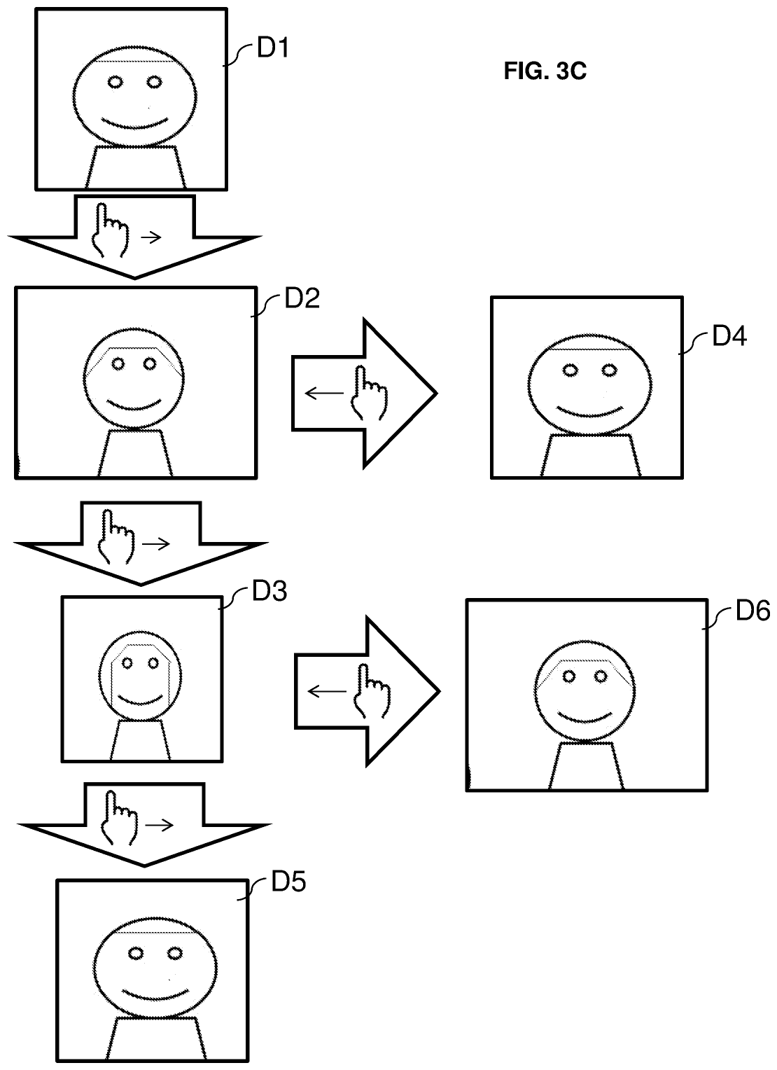

FIGS. 3A-3C illustrate an example of the processing of such a plurality of objects of interest in an image, using an embodiment of the method according to the present invention.

In particular, FIG. 3A illustrates an image which is a group photo depicting three persons, this group photo having a size p.

When such a group photo is selected by the user using the interface 13, it is first determined if this group photo depicts object(s) of interest. In the present case, there are three objects of interest OOI₁, OOI₂ and OOI₃ identified in this group photo, and three areas A(OOI₁), A(OOI₂) and A(OOI₃) corresponding to each of these objects are defined (here surrounding the face of a person determined as being an object of interest) as illustrated in FIG. 3B.

For each of these area A(OOIᵢ), a focal point fpᵢ is defined (typically the center of the area) and the coordinates of this focal point in the photo are determined. Furthermore, for each of these area A(OOIᵢ), the size fᵢ of the area is obtained.

Since at least one object of interest has been detected as being depicted in the selected group photo, the “zooming state” is then entered and a zoom in operation is performed automatically on the first object OOI₁, by focusing the zoom in on the focal point fp₁ and applying a zoom ratio n₁*p/f₁, for instance using n₁=0.2. The result is then displayed at the interface 13, as illustrated by the display view D1 in FIG. 3C.

If a first OOI swapping action is detected later at interface 13, a zoom in operation is performed on the second object OOI₂, by focusing the zoom in on the focal point fp₂ and applying a zoom ratio n₂*p/f₂, for instance using n₂=0.2 The result is then displayed at the interface 13, instead of the previously displayed object OOI₁, as illustrated by the display view D2 in FIG. 3C.

If a second OOI swapping action is detected later at interface 13, and if this second OOI swapping action corresponds to the switching to a new OOI (for instance a sliding gesture from the left to the right), a zoom in operation is performed on the third object OOI₃, by focusing the zoom in on the focal point fps and applying a zoom ratio n₃*p/f₃, for instance using n₃=0.2 The result is then displayed at the interface 13, instead of the previously displayed object OOI₂, as illustrated by the display view D3 in FIG. 3C. On the other hand, if this second OOI swapping action corresponds to the switching to the previously displayed OOI (for instance a sliding gesture from the right to the left), a zoom in operation is performed on the first object OOI₃, by focusing again the zoom in on the focal point fp₁ and applying again the zoom ratio n₁*p/f₁. The result is then displayed at the interface 13, instead of the previously displayed object OOI₂, as illustrated by the display view D4 in FIG. 3C.

Once the third and last object of interest OOI₃ is displayed, if a third OOI swapping action is detected later at interface 13, and if this third OOI swapping action corresponds to the switching to a new OOI (for instance a sliding gesture from the left to the right), a zoom in operation may be performed again on the first object OOI₁ in a specific embodiment, by focusing again the zoom in on the focal point fp₁ and applying again the zoom ratio n₁*p/f₁, the result being displayed at the interface 13, instead of the previously displayed object OOI₃, as illustrated by the display view D5 in FIG. 3C, and so on. On the other hand, a third OOI swapping action corresponding to the switching to the previously displayed OOI (for instance a sliding gesture from the right left to the left), would lead to display again the second object OOI₂, as illustrated by the display view D6 in FIG. 3C.

In this specific embodiment, the OOI swapping actions are therefore only foreseen to change the focus on displayed objects of interest within the same image, without changing the image depicting these objects of interest. Alternatively, in another embodiment, this third OOI swapping action may trigger the selection of another image on which to start again performing automatically the zoom in on a first object of interest of this other image.

Referring back to FIG. 2, the method may further comprise detecting (d″) another image selection action (also named “image swapping action”) performed by the user at the interface 13, in particular a fast swipe touch gesture (by contrast with a slow swipe gesture action). When such an image swapping action is detected at the interface 13, a second image is selected (a′) and the determining and selecting steps (b) and (c) may be repeated for this second image (i.e. displaying, at the interface 13, the second image automatically zoomed in on a detected first object of interest depicted by this second image, etc.).

Regarding the plurality of objects of interest, the first, second, etc. objects may be arbitrarily or even randomly ordered, but in an embodiment, the method further comprises selecting (c1) the first object of interest among the plurality of objects of interest depicted in the first image. In another embodiment, the method additionally comprises selecting (f1) the second object of interest among the remaining of objects of interest depicted in the first image (i.e. excluding the already selected first object of interest).

There may be a lot of criteria for such an object of interest selection, including:
a tagging order of tags associated the object of interest(s);
frequency apparition of the object of interest(s);
a location distribution within the first image (i.e. for example starting from the top left corner and finishing by the bottom right corner of the first image),
selecting the first object of interest based on the possible zoom activation action (the object the closest from the zooming point if such zooming activation action is a zooming in action), and selecting the further objects of interest based on the zoom swapping action (determining a swipe direction and selecting the next object in this direction);
a combination thereof.

Therefore, when the user performs the OOI swapping action in the zooming state, the first image may be zoomed in on the next most frequent face tagged for instance.

### Zooming Out

In any case, the method may comprise a further step (not illustrated in FIG. 2) of, when detecting a zoom cancellation action (again different at least from the above mentioned actions) performed by the user on the interface 13, displaying at the interface 13 the first image without any zooming in on an object of interest (i.e. as possibly displayed in step (a)). Note that further steps of the method may be then repeated, if for example a second image is selected thanks to an image selection action or if a zoom activation action is performed.

The idea of this zoom cancellation is to exit the zooming state and to display the first image “zoomed out”, i.e. back to its original size.

Thus, the zoom cancellation action may be the opposite of the zoom activation action, for instance a zooming out action when the zoom activation action is a zooming in action. For instance, if the zoom activation action is a touch gesture of the fast “pinch-out” type, the zoom cancellation action may be a touch gesture of the fast “pinch-in” type. In some case there may be a common action for zooming in and zooming out, for example a long duration touch gesture alternating zooming in and zooming out.

Again, the zooming out may be automatically performed by the electronic device 1, and thus totally independent from the nature of the detected possible zooming cancellation action. Zooming out the zoomed in first image corresponds to multiplying its dimension by the zoom ratio which has a value (between zero and one) equal to the inverse of the currently applied zoom ratio (for example if the zoom ratio currently applied has a value of 4, a zooming ratio of 0.25 is applied for reverting to a zooming ratio of 1, i.e. the first image is displayed at the original size).

This step of displaying, at the interface 13, the first image without any zooming in on an object of interest may also be performed either directly (the first image is re-displayed) or may comprise progressively zooming out the first image, i.e. from the displaying of step (c) or (e) the first image reduces in size, instead of directly appearing at the original aspect. The duration of this size reduction may also be done to mimic a manual zooming out.

Out of the zooming state, an image selection action can then be used to select another image.

### Device and Computer Program

In a second aspect, the present invention proposes an electronic device 1 for performing the method according to the first aspect. This electronic device 1 comprises a processing unit 11 and an interface 13, possibly a memory 12 and/or an acquisition unit 14 such as a camera.

This processing unit 11 is configured to implement:
determining that a first image, selected for being displayed at the interface 13, depicts at least a first object of interest; and
displaying, at the interface 13, the first image automatically zoomed in on the first object of interest.

The processing unit 11 may be further configured to implement one, several, or all of the following operations, as already described before:
detecting an image selection action at the interface 13, the display of said image automatically zoomed in on said first object of interest being triggered by the detection of the image selection action,
detecting a zoom adjustment action at the interface 13 and, following the detection of such an image swapping action, adjusting at least one zoom parameter used for automatically zooming in on the first object of interest, depending on said zoom adjustment action,
detecting an image swapping action at said interface 13 and, following the detection of such an image swapping action, determined that this a second image depicts at least a first object of interest and displaying, at the interface 13, this second image automatically zoomed in on the first object of interest,
detecting an object of interest swapping action at said interface 13, following the detection of such an object of interest swapping action, displaying, at the interface 13, the image automatically zoomed in on the second object of interest,
detecting a zoom cancelling action on said interface 13 and, following the detection of such a zoom cancelling action, displaying at the interface 13 the first image without any zooming in on an object of interest.

In a specific embodiment where the processing unit 11 is configured to implement all of the above-mentioned operations, the following gestures can be detected in order to distinguish the different operations to be performed:
the image selection action may be a fast swipe touch gesture at the interface 13 (i.e. moving and touching during a period less than 0.5 seconds);
the zoom adjustment action may be a slow pinch gesture by two fingers of a user at the interface 13 (i.e. a pinch gesture but both fingers keep touching during a period exceeding 0.5 seconds), with the position of the middle point of the two touch points moving to a new location on interface 13;
the object of interest swapping action may be a fast swapping gesture of a user at interface 13 (i.e. moving and touching during a period less than 0.5 seconds); and
the zoom cancellation action may be a fast pinch gesture by two fingers of a user at interface 13 (i.e. a pinch gesture with both fingers keep touching during a period less than 0.5 seconds).

The invention further proposes a computer program product, comprising code instructions for executing (in particular with its processing unit 11) a method according to the first aspect for operating an electronic device 1; and a computer-readable medium (in particular the memory 12 of the device 1), on which is stored a computer program product comprising code instructions for executing this method.

1. A method for operating an electronic device, wherein the method is performed by a processing unit of the device and comprises:
determining that a first image, selected for being displayed at an interface of the device, depicts at least a first object of interest; and
displaying, at the interface, said first image automatically zoomed in on said first object of interest.

2. The method according to claim 1, further comprising detecting an image selection action at the interface, the displaying of said image automatically zoomed in on said first object of interest being triggered by the detection of the image selection action.

3. The method according to claim 2, wherein said interface comprises a touch-sensitive screen and said image selection action is an action among a swipe touch gesture performed on a previous image in a group of images whereof said first image belongs to or a touch gesture on a thumbnail picture of said image in an album object displayed at said interface.

4. The method according to claim 1, further comprising detecting a zoom adjustment action at said interface and adjusting at least one zoom parameter used for automatically zooming in on the first object of interest, depending on said zoom adjustment action.

5. The method according to claim 4, wherein said interface comprises a touch-sensitive screen and said zoom adjustment action comprises a pinch in or pinch out gesture for adjusting a zoom ratio used for automatically zooming in on the first object of interest or a sliding gesture for adjusting a focal point used for automatically zooming in on the first object of interest.

6. The method according to claim 1, further comprising detecting an image swapping action at said interface and performing the determining and displaying for a second image selected following said image swapping action.

7. The method according to claim 6, wherein said interface is a touch-sensitive screen and said image selection action is a touch gesture by the user, in particular a fast swipe gesture.

8. The method according to claim 1, comprising determining that said image depicts a plurality of objects of interest including said first object of interest and a second object of interest; and selecting the first object of interest among the plurality of objects of interest before displaying said image automatically zoomed in on said first object of interest.

9. The method according to claim 8, further comprising detecting an object of interest swapping action at said interface and displaying at the interface said first image automatically zoomed in on the second object of interest.

10. The method according to claim 9, wherein said interface comprises a touch-sensitive screen and said object of interest swapping action comprises a slow swipe touch gesture by the user.

11. The method according to claim 9, further comprising selecting the second object of interest among the plurality of objects of interest before displaying said image automatically zoomed in on the second object of interest.

12. The method according to claim 1, wherein a zoom ratio applied during the display of an image automatically zoomed in on an object of interest is function of the size of an area containing said first or second object of interest and the total size of the first image.

13. The method according to claim 1, comprising detecting a zoom cancelling action on said interface and displaying at the interface said first image without any zooming in on an object of interest in response to the zoom cancelling action.

14. An electronic device comprising:
an interface; and
a processing unit configured to implement:
determining that a first image, selected for being displayed at the interface, depicts at least a first object of interest; and
displaying, at the interface, said first image automatically zoomed in on said first object of interest.

15. (canceled)

16. A non-transitory computer-readable medium, on which is stored a computer program product comprising code instructions for executing for operating an electronic device when the code instructions are executed by a processing unit of the electronic device, wherein the code instructions configure the electronic device to:
determine that a first image, selected for being displayed at an interface of the device, depicts at least a first object of interest; and
display, at the interface, said first image automatically zoomed in on said first object of interest.
